(19) United States
(12) Patent Application Publication
(10) Pub. No.: US 2026/0259304 A1
(43) Pub. Date: Sep. 3, 2026

(54) LIDAR WITH SPLIT AND AMPLIFY ARCHITECTURE AND INTEGRATED PROTECTION SWITCHES

(71) Applicant: nEye Systems, Inc., Emeryville, CA (US)

(72) Inventors: Ming Chiang A. WU, Piedmont, CA (US); Tae Joon SEOK, El Cerrito, CA (US); Kyungmok KWON, El Cerrito, CA (US); Noriaki KANEDA, Westfield, NJ (US); Xiaosheng ZHANG, Davis, CA (US)

(21) Appl. No.: 18/875,336

(22) PCT Filed: Jun. 15, 2023
(86) PCT No.: PCT/US2023/068534

§ 371 Date: Dec. 16, 2024

Related U.S. Application Data
(60) Provisional application No. 63/352,557, filed on Jun. 15, 2022.

(51) Int. Cl. G01S 7/481; G01S 17/89

(52) U.S. Cl. CPC G01S 7/4815; G01S 17/89

(57) ABSTRACT

The present disclosure is directed to imaging LiDARs with separate transmit (Tx) and receive (Rx) optical antennas fed by different optical waveguides. This pair of optical antennas can be activated at the same time through a dual-channel optical switch network, with the Tx antenna connected to a laser source and the Rx antenna connected to a receiver. The Tx and Rx antennas can be positioned adjacent to each other, so they point to approximately the same far-field angle. No optical alignment between the Tx and Rx is necessary. This LiDAR configuration, referred to herein as pseudo-monostatic LiDAR, eliminates spurious reflections and increases the dynamic range of the LiDAR.

### PRIORITY

This patent application claims priority to U.S. Provisional Patent Application No. 63/352,557, entitled “LIDAR WITH SPLIT AND AMPLIFY ARCHITECTURE AND INTEGRATED PROTECTION SWITCHES”, and filed on Jun. 15, 2022, which is herein incorporated by reference in its entirety.

### FIELD

The present disclosure details novel LiDAR systems and methods. More specifically, this disclosure is directed to imaging LiDARs with features to increase the performance and reliability of silicon photonic LiDARs.

### BACKGROUND

Light detection and ranging (LiDAR) is widely used in autonomous vehicles and portable devices such as smartphones and tablets. Solid state LiDARs are particularly attractive because they are conducive to miniaturization and mass production. US Patent Pub. No. 2021/0116778 teaches a beamsteering system consisting of a programmable array of vertical couplers (also called optical antennas) located at the focal plane of an imaging lens. Optical signals can be delivered to any selected optical antenna through a programmable optical network consisting of MEMS (micro-electro-mechanical system)-actuated waveguide switches. Compared with conventional thermo-optic or electro-optic switches, the MEMS switches offer lower insertion loss, lower crosstalk, broadband operation, and digital actuation. High density arrays of programmable optical antennas having small footprints can be integrated on single chips for high resolution imaging LiDARs.

Previous work used the same optical antenna to transmit the interrogating optical beam and receive the optical signal reflected from the target. A drawback of this architecture is that any residue reflections from the optical antenna and the shared optical path will be mixed with the received optical signals. The spurious reflections degrade the signal-to-noise ratio and could saturate the amplifiers in the receiver, preventing the LiDAR from seeing far-away targets or targets with low reflectivity.

Lasers and optical amplifiers are high current devices and are prone to failure during operation. For LiDARs with integrated lasers and amplifiers, failure may also happen during fabrication. Failed lasers or amplifiers can lead to dead spots in the field of view causing the LiDAR to no longer be fully functional.

### SUMMARY

An imaging LiDAR system is provided, comprising: a laser array comprising a plurality of light emitters; a LiDAR array including a plurality of optical antennas having transmit and receive functions, wherein a number of active channels in the LiDAR array is less than a number of light emitters in the laser array; a programmable optical network configured to provide a light path from active lasers of the laser array to a selected optical antenna of the LiDAR array; and a first plurality of monitoring devices configured to monitor a health of the active lasers of the laser array.

In one aspect, the imaging LiDAR system further comprises an optical switch coupled to the laser array.

In one aspect, the plurality of optical antennas and the programmable optical network are integrated on a photonic integrated circuit

In one aspect, the optical switch is configured to select the active lasers from the array of lasers to feed the LiDAR array.

In one aspect, the first plurality of monitoring devices are coupled to the optical switch.

In one aspect, the first plurality of monitoring devices comprise at least one monitoring photodiode.

In one aspect, the at least one monitoring photodiode is positioned at each through port of the optical switch.

In one aspect, the first plurality of monitoring devices are configured to monitor a photocurrent level of each active laser.

In one aspect, the system further comprises a second plurality of monitoring devices configured to monitor periodic change of optical power as light energy is directed to the LiDAR array.

In one aspect, the second plurality of monitoring devices comprise a plurality of monitoring photodiodes in the LiDAR array.

In one aspect, the plurality of monitoring photodiodes are integrated into row waveguides of the programmable optical network.

In one aspect, the system further comprises a plurality of splitters optically coupled to each active laser.

In one aspect, the system further comprises an optical amplifier coupled to each output of the plurality of splitters, the optical amplifiers being configured to compensate for splitting loss through the plurality of splitters.

In one aspect, the system further comprises a second plurality of monitoring devices configured to monitor periodic change of optical power as light energy is directed to the LiDAR array through the plurality of splitters and optical amplifiers.

In one aspect, the second plurality of monitoring devices comprises a plurality of monitoring photodiodes in the programmable optical network.

In one aspect, a photocurrent measured by the second plurality of monitoring photodiodes can be used to monitor a health of the optical amplifiers.

In one aspect, the second plurality of monitoring devices are integrated at the end of row waveguides in the LiDAR array.

In one aspect, the programmable optical network is controlled by one or more micro-electro-mechanical system (MEMS) actuators, or Mach-Zehnder interferometers with electro-optic or thermo-optic phase modulators, or mirroring resonators with electro-optic or thermo-optic phase modulators.

In one aspect, the imaging LiDAR system further comprises a plurality of splitters optically coupled to the array of lasers and at least one optical amplifier coupled to each of the plurality of splitters, the optical amplifiers configured to compensate for splitting loss through the plurality of splitters.

In one aspect, the system further comprises a coupler configured to tap off a small portion of power from the laser array as local oscillator light to a coherent receiver.

In one aspect, reflected light from the LiDAR array is sent through a directional coupler to be mixed with the local oscillator light.

In one aspect, the system further comprises a direct detection receiver optically coupled to each optical amplifier.

In one aspect, the plurality of optical antennas comprise separate transmit and receive optical antennas, wherein the programmable optical network comprises a transmit waveguide optically connected to the transmit optical antennas and a receive waveguide optically connected to the receive optical antennas.

In one aspect, the system further comprises a plurality of optical isolators positioned between the laser array and the LiDAR array, the plurality of optical isolators being configured to suppress residue reflections.

In one aspect, the system further comprises a plurality of protection switches positioned between the optical switch and the LiDAR array, the plurality of protection switches being configured to select a spare optical amplifier in the event of a degraded or non-functional optical amplifier.

A method of performing LiDAR imaging is provided, comprising: optically coupling a subset of light emitters of a laser array to an array of optical antennas; monitoring an output power of each of the subset of light emitters; if the output power of a specific light emitter drops below a failure threshold, activating a spare light emitter from the laser array to replace the specific light emitter.

In one aspect, monitoring the output power is performed with a group of monitoring photodiodes coupled to an output of the subset of light emitters.

In one aspect, activating the spare light emitter is performed with an optical switch coupled to the laser array.

In one aspect, the array of optical antennas has fewer channels than a number of light emitters of the laser array.

A method of performing LiDAR imaging is provided, comprising: optically coupling a laser array to an array of optical antennas through a plurality of optical amplifiers with a plurality of waveguides; monitoring an output power the laser array in the plurality of waveguides; if the output power in a specific waveguide drops below a failure threshold, activating a spare optical amplifier to replace a specific optical amplifier corresponding to the specific waveguide.

In one aspect, monitoring the output power is performed with a group of monitoring photodiodes coupled to the plurality of waveguides.

In one aspect, activating the spare optical amplifier is performed with an optical switch coupled to the array of optical antennas.

In one aspect, the array of optical antennas has fewer channels than a number of available optical amplifiers.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is schematic of an exemplary imaging LiDAR with an imaging lens and focal plane switch array.

FIG. 2 is a schematic of a focal-plane-array LiDAR with split-and-amplify architecture and integrated protection switches to bypass the failed lasers or optical amplifiers.

FIG. 3 shows an embodiment of a sub-array for monostatic LiDAR with coherent receivers.

FIG. 4 shows an embodiment of a sub-array for monostatic LiDAR with direct-detection receivers.

FIG. 5 shows an embodiment of a sub-array for pseudo-monostatic LiDAR with coherent receivers.

FIG. 6 shows an embodiment of a sub-array for pseudo-monostatic LiDAR with direct-detection receivers.

FIG. 7 shows an embodiment of a N×M switch and monitoring PDs at the through ports.

FIG. 8 shows an embodiment of a LiDAR with external lasers.

FIG. 9 shows a schematic of a LiDAR with additional protection switches for optical amplifiers.

FIG. 10 shows a schematic of a LiDAR transmitter with protection switches.

### DETAILED DESCRIPTION

Patent application (U.S. Ser. No. 17/687,372, incorporated herein in its entirety) describes a solid-state LiDAR with focal-plane switch array. Each pixel in the array is mapped to a distinctive direction within the field of view of the imaging lens. The laser power is delivered to a given pixel through an integrated optical switch network. The reflected light is either collected by the same optical antenna (monostatic architecture) or a separate optical antenna (pseudo-monostatic architecture) and sent to receivers to analyze the time of flight. In this architecture, each laser powers a selected row of pixels at a time. Multiple lasers can be used to operate multiple rows at the same time to speed up the operation. However, these lasers need to be individually controlled to provide optimum modulation. For example, in continuous-wave frequency-modulated (FMCW) LiDAR systems, linear frequency modulation is required for each laser.

This disclosure provides a split-and-amplify architecture to enable a single laser to power multiple rows of pixels and simplify the control of the laser source. In some embodiments, the optical amplifiers are integrated with the LiDAR chip though hybrid integration of an optical amplifier chip and a silicon photonic chip. This can significantly increase the yield of integrated photonic LiDARs. It also greatly increases the reliability and lifetime of the LiDAR. The protection switches provide redundancy of critical elements. The failed elements can be replaced by spare elements even during operation.

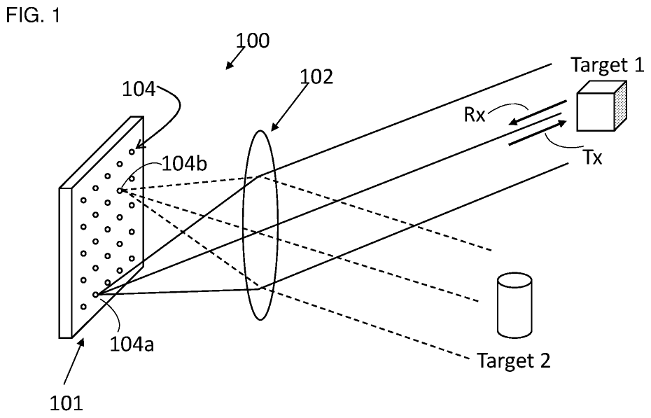

One example schematic of an imaging LiDAR 100 is shown in FIG. 1. A photonic integrated circuit (PIC) 101 with a two-dimensional (2D) array of optical antennas 104 is placed at the focal plane of an imaging lens 102. An optical switch network in the PIC selectively activates one or more optical antennas 104 at a time. Each activated optical antenna transmits light to a certain direction (Tx) and the same antenna receives reflected light from target (Rx). This creates a one-to-one mapping between the lateral position of the optical antenna and the far-field angle, as illustrated by the optical beam paths from two separate optical antennas 104a, 104b, pointing to Target 1 and Target 2, respectively. This is referred to herein as monostatic LiDAR, in which the transmitter and the receiver share the same optical antenna. The LiDAR 100 of FIG. 1 can additionally use pseudo-monostatic imaging LiDAR in which the transmitter and the receiver use separate optical antennas and separate optical waveguides to feed the transmit and receive antennas. Thus, while monostatic LiDAR uses an array of optical antennas in which the antenna at each pixel location comprises a combination transmit/receive antenna, pseudo-monostatic imaging LiDAR uses an array of optical antennas with separate transmit antennas and receive antennas for each pixel at the focal plane of the imaging lens.

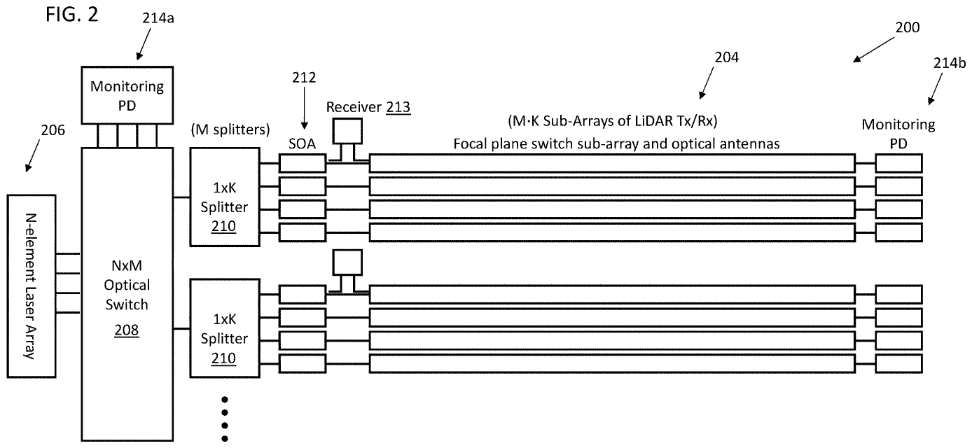

FIG. 2 is a schematic of a focal-plane-array LiDAR 200 with split-and-amplify architecture and integrated protection switches to bypass failed lasers and/or optical amplifiers. The LiDAR 200 of FIG. 2 can include M*K sub-arrays of LiDAR Tx/Rx antennas 204 as previously described. As shown in FIG. 2, a light emitter array, shown as an N-element laser array 206, is used as optical source for the LiDAR array. The number of lasers (N) in the laser array 206 is greater than the number of active channels (M) in the array of Tx/Rx antennas 204. An N×M switch 208 can be configured to select M active lasers from the laser array 206 to feed the LiDAR array 204. The remaining (N-M) elements of the laser array are spare lasers that can be turned on when one or more of the other lasers fail. In one embodiment, the N×M switch comprises silicon photonic MEMS switches like those described in U.S. Pat. Nos. 10,061,085, 10,715,887, or 11,360,272. Each of the selected laser(s) is connected to a 1×K splitter 210, so there can be a total of M splitters 210. To compensate for splitting loss through the splitter(s), a semiconductor optical amplifier (SOA) 212 can be integrated at each output of the splitter(s) to boost up the optical power. The amplified light can then be sent to a sub-array of LiDAR elements as described in U.S. Ser. No. 17/687,372. One or more receivers 213 can be coupled to the sub arrays of optical antennas to enable receive functions of the arrays, as shown. Some embodiments of the sub-array will be described later.

In this embodiment, two groups of monitoring photodiodes (PDs) 214a and 214b are included in the system. The first group of monitoring PDs 214a is positioned at the “through” ports of the N×M optical switches 208. When a laser is selected, most of the laser power is directed to the “drop” port (e.g., in the direction of the splitters 210 and array 204). A small portion of the optical power (e.g., up to 1%, up to 5%, up to 10%, etc.) will remain in the “through” port. Thus, the PDs 214a can be configured to monitor the photocurrent of the PD at each through port of the switch(es) 208, thereby monitoring the power level of each operating laser. When laser power on one of the through ports starts to drop, it may be an indication that the laser is degrading. In case of catastrophic failure, the photocurrents will drop significantly (e.g., below a failure threshold). In the event of failure or degradation of one of the active lasers, the optical switch can be configured to disable the affected laser and turn on or activate a spare laser from the laser array. A second group of PDs 214b can be integrated at the end of the row waveguides in each sub-array 204. During normal operation, the second group of PDs 214b are configured to monitor and observe periodic change of optical power as the laser light is directed to pixels in successive columns by the column-selection switches. The photocurrent and its variation measured by PDs 214b can therefore be used to monitor the health of the optical amplifiers 212 and the column-selection switches or splitters 210. Similar to PD 214a, if the measured laser power at PD 214b starts to drop, it can be an indication that the optical amplifiers and/or column-selection switches are degrading. If the photocurrents drop below a failure threshold, it can be an indication of catastrophic failures of the optical amplifiers and/or column-selection switches. In some embodiments (described below), the system can be configured to switch or turn on a spare optical amplifier in the event of a failure or degradation.

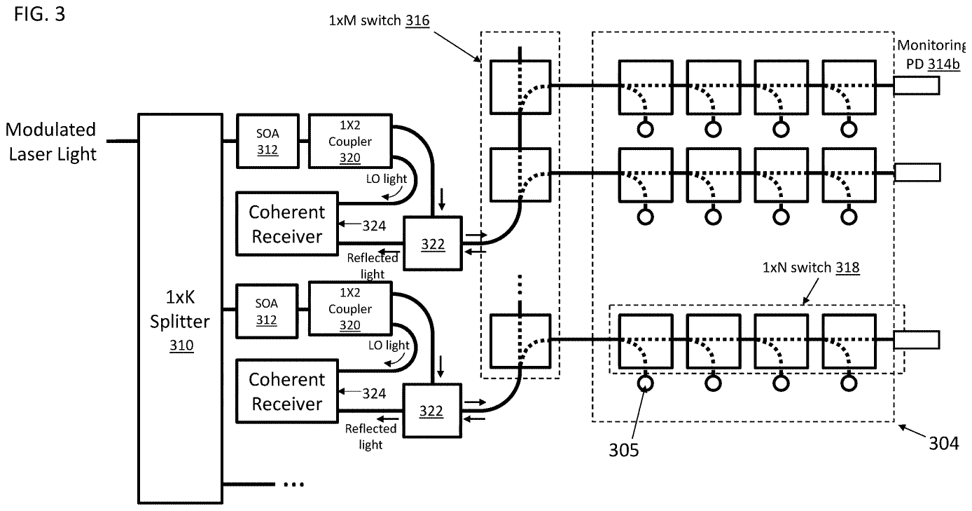

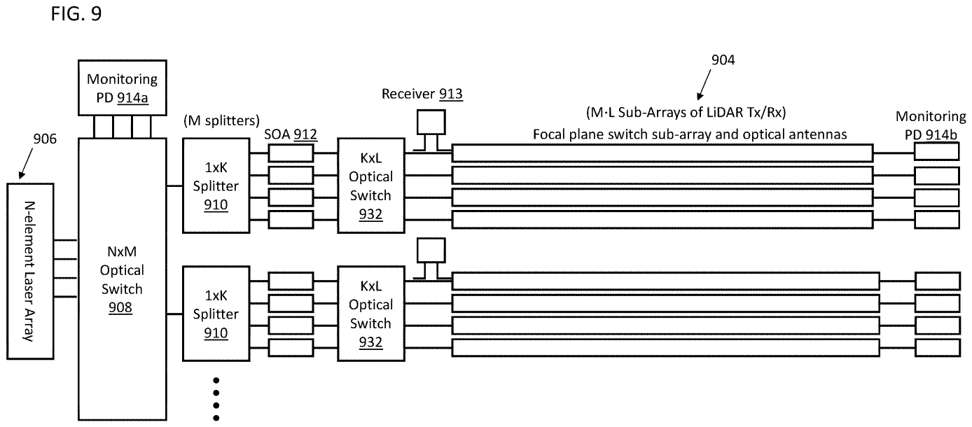

FIG. 3 shows an embodiment of the sub-array for monostatic LiDAR with coherent receivers. FIG. 3 illustrates a programmable optical network that uses a 1×M switch (row selection switch 316) to select the active row and a 1×N switch (column selection switch 318) to select the optical antenna 304 (FIG. 3 shows a M×N array 304 of optical antennas 305). It should be understood that in some embodiments, the optical antennas can comprise transmit and receive optical antennas integrated into a single antenna. In other embodiments described below, the transmit and receive antennas can be separated. The antennas 305 are illustrated as a single structure for ease of illustration in FIG. 3. The programmable optical network can be coupled to modulated laser light, as shown. The laser light is modulated, either directly or through a modulator, to generate interrogating light. In some embodiments, the modulated laser light comes from the N-element laser array and N×M optical switch described above in the embodiment of FIG. 2. In a pulsed time of flight system, the laser is modulated to produce short (~nanosecond) optical pulses, and the receivers are made of avalanche photodiodes (APD) or single photon avalanche diodes (SPAD). In a frequency-modulated continuous-wave (FMCW) system, the laser frequency increase or decrease linearly with time. While the column selection switch 318 and optical antenna array 304 are shown in FIG. 3 to be the same size (M×N), in other embodiments, different sizes can be implemented, for example as shown in FIG. 9.

The modulated laser light for each of the selected laser(s) is connected to a 1×K splitter 310, so there can be a total of M splitters 310. To compensate for splitting loss through the splitter(s) 310, a semiconductor optical amplifier 312 can optionally be integrated at the output of each splitter(s) to boost up the optical power. Here, a small portion of the laser power (e.g., up to 1%, up to 5%, up to 10%) at each output of the splitter is tapped off as local oscillator (LO) light by a 1×2 coupler 320 and sent to a coherent receiver 324. The other split light from the laser and the 1×2 coupler is the target signal, which is sent to a target via a selected transmit optical antenna(s) 305 and the reflected light from the target is received by the receive optical antenna(s) 305 and sent through directional coupler 322 to the coherent receiver 324 to be mixed (interfered) with the LO light. While a directional coupler is illustrated in this embodiment, other similar structures including circulators can be implemented.

The embodiment of FIG. 3 can further incorporate the two groups of monitoring photodiodes (PDs) discussed above in FIG. 2. For example, the source of modulated laser light can include a first group of monitoring PDs (not shown, but illustrated in FIG. 2) positioned at the “through” ports of the N×M optical switches of the modulated laser light source. When a laser is selected, most of the laser power is directed to the “drop” port. A small portion of the optical power (e.g., up to 1%, up to 5%, up to 10%, etc.) will remain in the “through” port. Thus, the first group of PDs can be configured to monitor the photocurrent of the PD at each through port of the switch(es), thereby monitoring the power level of each operating laser. When laser power on one of the through ports starts to drop, it may be an indication that the laser is degrading. In case of catastrophic failure, the photocurrents will drop significantly (e.g., below a failure threshold). In the event of failure or degradation of one of the active lasers, the optical switch can be configured to disable the affected laser and turn on or activate a spare laser from the laser array. A second group of PDs 314b can be integrated at the end of the row waveguides in each sub-array 304. During normal operation, the second group of PDs 314b are configured to monitor and observe periodic change of optical power as the laser light is directed to pixels in successive columns by the column-selection switches. The photocurrent and its variation measured by PDs 314b can therefore be used to monitor the health of the optical amplifiers 312, couplers 320, couplers 322, and/or switches 316 and 318. If the measured laser power at PD 314b starts to drop, it can be an indication that these components are degrading. If the photocurrents drop below a failure threshold, it can be an indication of catastrophic failures of one or more of these components in the optical path. In some embodiments (described below), the system can be configured to switch or turn on a spare optical amplifier in the event of a failure or degradation.

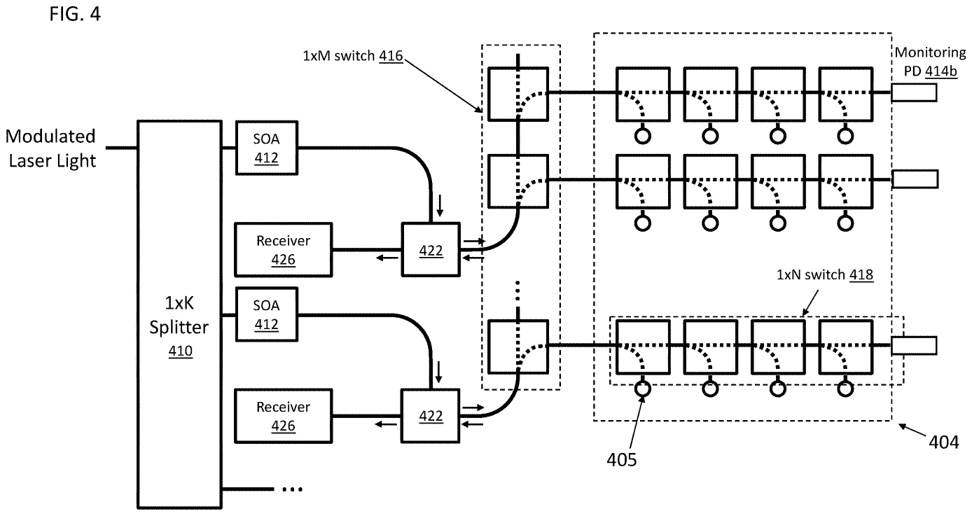

FIG. 4 shows an embodiment of a sub-array for monostatic LiDAR with direct-detection receivers. The embodiment of FIG. 4 is similar to the embodiment of FIG. 3, and includes modulated laser light, a 1×K splitter 410, semiconductor optical amplifiers (SOA) 412 integrated at each output of the splitter 410, 1×M row switch 416, 1×N column switch 418, and a M×N array 404 of optical antennas 405. However, in this embodiment, received signals are sent through directional coupler 422 to direct-detection receivers 426. The signals are then sent for further processing (not shown).

The embodiment of FIG. 4 can further incorporate the two groups of monitoring photodiodes (PDs) discussed above in FIG. 2. For example, the source of modulated laser light can include a first group of monitoring PDs (not shown, but illustrated in FIG. 2) positioned at the “through” ports of the N×M optical switches of the modulated laser light source. When a laser is selected, most of the laser power is directed to the “drop” port. A small portion of the optical power (e.g., up to 1%, up to 5%, up to 10%, etc.) will remain in the “through” port. Thus, the first group of PDs can be configured to monitor the photocurrent of the PD at each through port of the switch(es), thereby monitoring the power level of each operating laser. When laser power on one of the through ports starts to drop, it may be an indication that the laser is degrading. In case of catastrophic failure, the photocurrents will drop significantly (e.g., below a failure threshold). In the event of failure or degradation of one of the active lasers, the optical switch can be configured to disable the affected laser and turn on or activate a spare laser from the laser array. A second group of PDs 414b can be integrated at the end of the row waveguides in each sub-array 404. During normal operation, the second group of PDs 414b are configured to monitor and observe periodic change of optical power as the laser light is directed to pixels in successive columns by the column-selection switches. The photocurrent and its variation measured by PDs 414b can therefore be used to monitor the health of the optical amplifiers 412, couplers 422, and/or switches 416 and 418. If the measured laser power at PD 414b starts to drop, it can be an indication that these components are degrading. If the photocurrents drop below a failure threshold, it can be an indication of catastrophic failures of one or more of these components in the optical path. In some embodiments (described below), the system can be configured to switch or turn on a spare optical amplifier in the event of a failure or degradation.

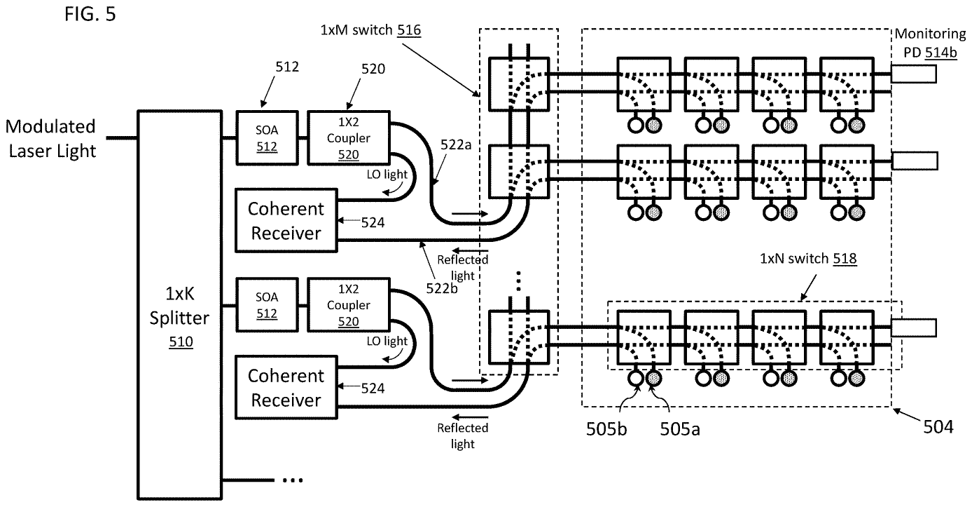

FIG. 5 shows an embodiment of the sub-array for pseudo-monostatic LiDAR with coherent receivers. The embodiment of FIG. 5 is similar to the embodiment of FIG. 3, and includes modulated laser light, a 1×K splitter 510, semiconductor optical amplifiers 512 integrated at each output of the splitter 510, 1×2 couplers 520, dual channel 1×M row switch 516, 1×N column switch 518, and a M×N array 504 of optical antennas. However, in this embodiment, a directional coupler can be omitted because the transmit (Tx) optical antennas 505a are separate from the receive (Rx) optical antennas 505b. As a result, two separate waveguides, such as transmit waveguide(s) 522a and receive waveguide(s) 522b, are used to connect the transmit (Tx) optical antennas 505a and receive (Rx) optical antennas 505b. Here, a small portion of the laser power is tapped off as the local oscillator (LO) light by a 1×2 coupler 520 and sent to the coherent receiver 524. The other split light from the laser and the 1×2 coupler is the target signal, which is sent to a target via the transmit optical antenna(s) and the reflected light from the target is received by the receive optical antenna(s) and sent to the coherent receiver 524 to be mixed (interfered) with the LO light.

The embodiment of FIG. 5 can further incorporate the two groups of monitoring photodiodes (PDs) discussed above in FIG. 2. For example, the source of modulated laser light can include a first group of monitoring PDs (not shown, but illustrated in FIG. 2) positioned at the “through” ports of the N×M optical switches of the modulated laser light source. When a laser is selected, most of the laser power is directed to the “drop” port. A small portion of the optical power (e.g., up to 1%, up to 5%, up to 10%, etc.) will remain in the “through” port. Thus, the first group of PDs can be configured to monitor the photocurrent of the PD at each through port of the switch(es), thereby monitoring the power level of each operating laser. When laser power on one of the through ports starts to drop, it may be an indication that the laser is degrading. In case of catastrophic failure, the photocurrents will drop significantly (e.g., below a failure threshold). A second group of PDs 514b can be integrated at the end of the row waveguides on the transmit waveguide(s) 522a in each sub-array 504. During normal operation, the second group of PDs 514b are configured to monitor and observe periodic change of optical power as the laser light is directed to pixels in successive columns by the column-selection switches. The photocurrent and its variation measured by PDs 514b can therefore be used to monitor the health of the optical amplifiers 512, couplers 520, couplers 522, and/or switches 516 and 518. If the measured laser power at PD 514b starts to drop, it can be an indication that these components are degrading. If the photocurrents drop below a failure threshold, it can be an indication of catastrophic failures of one or more of these components in the optical path. In some embodiments (described below), the system can be configured to switch or turn on a spare optical amplifier in the event of a failure or degradation.

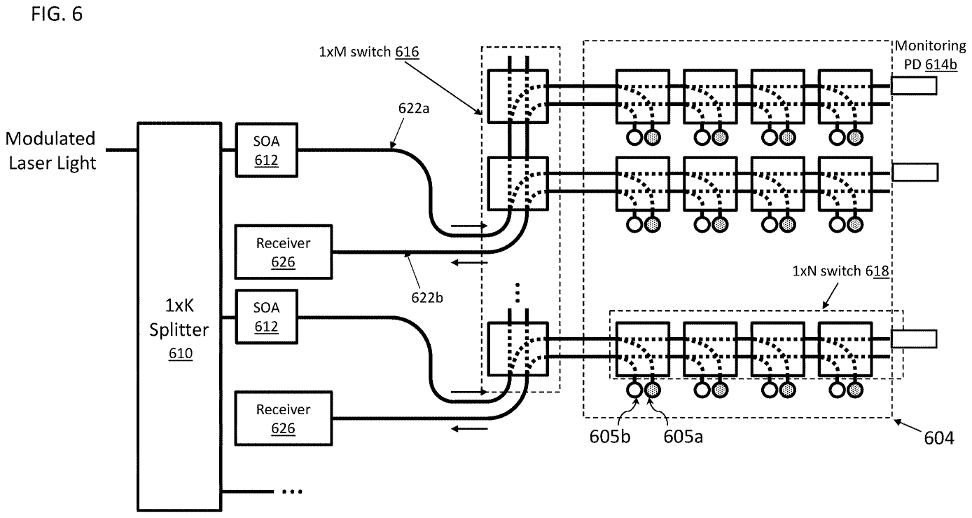

FIG. 6 shows an embodiment of the sub-array for pseudo-monostatic LiDAR with direct-detection receivers. This embodiment combines the pseudo-monostatic LiDAR array of the FIG. 5 embodiment with the direct-detection receivers of the FIG. 4 embodiment. Thus, the embodiment of FIG. 6 includes modulated laser light, a 1×K splitter 610, semiconductor optical amplifiers 612 integrated at each output of the splitter 610, direct-detection receivers 626, dual channel 1×M row switch 616, 1×N column switch 618, and a M×N array 604 of optical antennas with separate transmit (Tx) optical antennas 605a and receive (Rx) optical antennas 605b. Two separate waveguides, such as transmit waveguide(s) 622a and receive waveguide(s) 622b, are used to connect the transmit (Tx) optical antennas 605a and receive (Rx) optical antennas 605b.

The embodiment of FIG. 6 can further incorporate the two groups of monitoring photodiodes (PDs) discussed above in FIG. 2. For example, the source of modulated laser light can include a first group of monitoring PDs (not shown, but illustrated in FIG. 2) positioned at the “through” ports of the N×M optical switches of the modulated laser light source. When a laser is selected, most of the laser power is directed to the “drop” port. A small portion of the optical power (e.g., up to 1%, up to 5%, up to 10%, etc.) will remain in the “through” port. Thus, the first group of PDs can be configured to monitor the photocurrent of the PD at each through port of the switch(es), thereby monitoring the power level of each operating laser. When laser power on one of the through ports starts to drop, it may be an indication that the laser is degrading. In case of catastrophic failure, the photocurrents will drop significantly (e.g., below a failure threshold). In the event of failure or degradation of one of the active lasers, the optical switch can be configured to disable the affected laser and turn on or activate a spare laser from the laser array. A second group of PDs 614b can be integrated at the end of the row waveguides on the transmit waveguide(s) 622a in each sub-array 604. During normal operation, the second group of PDs 614b are configured to monitor and observe periodic change of optical power as the laser light is directed to pixels in successive columns by the column-selection switches. The photocurrent and its variation measured by PDs 614b can therefore be used to monitor the health of the optical amplifiers 612 and/or switches 616 and 618. If the measured laser power at PD 614b starts to drop, it can be an indication that these components are degrading. If the photocurrents drop below a failure threshold, it can be an indication of catastrophic failures of one or more of these components in the optical path. In some embodiments (described below), the system can be configured to switch or turn on a spare optical amplifier in the event of a failure or degradation.

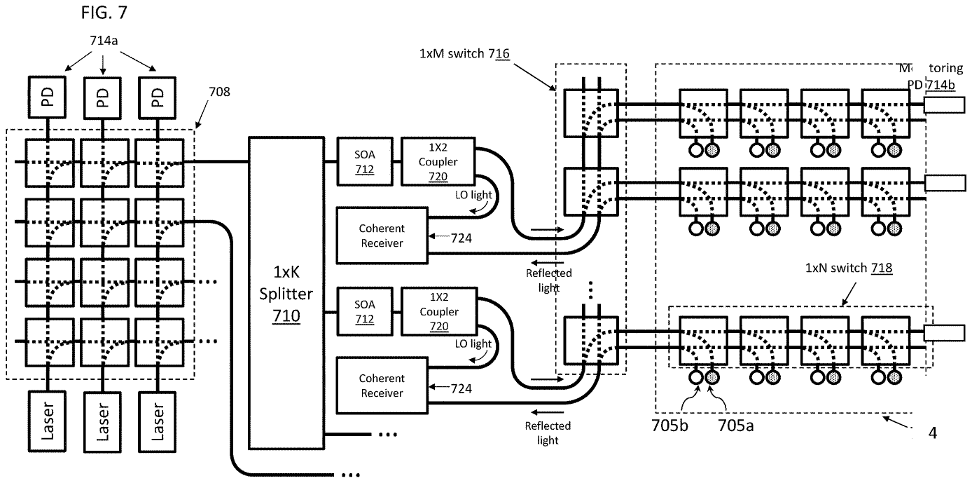

FIG. 7 shows another schematic of the FIG. 5 embodiment, which shows a pseudo-monostatic LiDAR system with coherent receivers. FIG. 7 further details and illustrates N×M switch 708 (which corresponds to switch 208 from FIG. 2) and the monitoring PDs 714a at the through ports of the switch 708. Each block shown in the switch 708 can be a 1×2 switch. FIG. 7 further shows splitter 710, SOAs 712, couplers 720, coherent receivers 724, 1×M row switch 716, 1×N column switch 718, and an array 704 of optical antennas that includes matched pairs of separate transmit (Tx) optical antennas 705a and receive (Rx) optical antennas 705b.

The embodiment of FIG. 7 incorporates the two groups of monitoring photodiodes (PDs) discussed above in FIG. 2. For example, the source of modulated laser light can include a first group of monitoring PDs 714a positioned at the “through” ports of the N×M optical switches of the modulated laser light source. When a laser is selected, most of the laser power is directed to the “drop” port. A small portion of the optical power (e.g., up to 1%, up to 5%, up to 10%, etc.) will remain in the “through” port. Thus, the first group of PDs can be configured to monitor the photocurrent of the PD at each through port of the switch(es), thereby monitoring the power level of each operating laser. When laser power on one of the through ports starts to drop, it may be an indication that the laser is degrading. In case of catastrophic failure, the photocurrents will drop significantly (e.g., below a failure threshold). In the event of failure or degradation of one of the active lasers, the optical switch can be configured to disable the affected laser and turn on or activate a spare laser from the laser array. A second group of PDs 714b can be integrated at the end of the row waveguides on the transmit waveguide(s) in each sub-array 704. During normal operation, the second group of PDs 714b are configured to monitor and observe periodic change of optical power as the laser light is directed to pixels in successive columns by the column-selection switches. The photocurrent and its variation measured by PDs 714b can therefore be used to monitor the health of the optical amplifiers 712, coupler 720, and/or switches 716 and 718. If the measured laser power at PD 714b starts to drop, it can be an indication that these components are degrading. If the photocurrents drop below a failure threshold, it can be an indication of catastrophic failures of one or more of these components in the optical path. In some embodiments (described below), the system can be configured to switch or turn on a spare optical amplifier in the event of a failure or degradation.

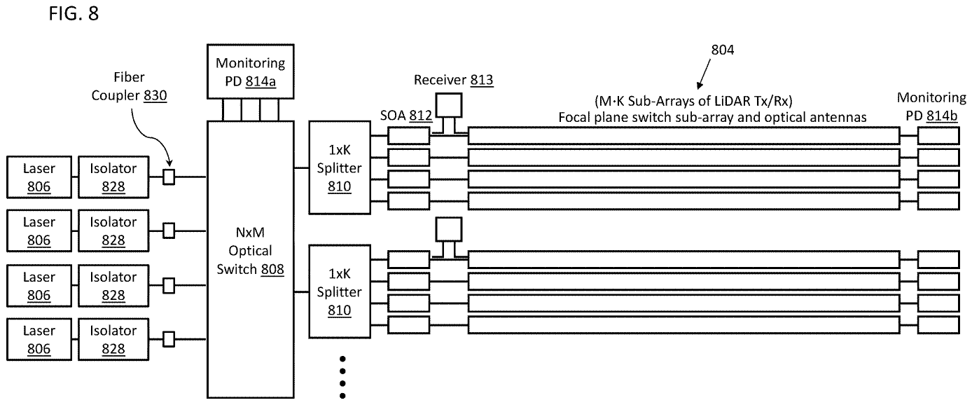

FIG. 8 shows an embodiment of the LiDAR in connection with one embodiment of the current invention and with external lasers. The embodiment of FIG. 8 is similar to the embodiment of FIG. 2, and includes a N×M optical switch 808 coupled to the output of a plurality of lasers 806, M sets of 1×K splitters 810, SOAs 812 on the output of each splitter, M*K sub arrays 804 of optical antennas, and receivers 813 for each sub-array. This embodiment allows optical isolators 828 to be positioned between each laser 806 and the LiDAR chip to suppress residue reflections. Fiber couplers 830 can additionally be implemented to optically couple the lasers to the LiDAR chip.

The embodiment of FIG. 8 incorporates the two groups of monitoring photodiodes (PDs) discussed above in FIG. 2. For example, the source of modulated laser light can include a first group of monitoring PDs 814a positioned at the “through” ports of the N×M optical switche 808 of the modulated laser light source. When a laser 806 is selected, most of the laser power is directed to the “drop” port. A small portion of the optical power (e.g., up to 1%, up to 5%, up to 10%, etc.) will remain in the “through” port. Thus, the first group of PDs can be configured to monitor the photocurrent of the PD at each through port of the switch(es), thereby monitoring the power level of each operating laser. When laser power on one of the through ports starts to drop, it may be an indication that the laser is degrading. In case of catastrophic failure, the photocurrents will drop significantly (e.g., below a failure threshold). In the event of failure or degradation of one of the active lasers, the optical switch can be configured to disable the affected laser and turn on or activate a spare laser from the laser array. A second group of PDs 814b can be integrated at the end of the row waveguides on the transmit waveguide(s) in each sub-array 804. During normal operation, the second group of PDs 814b are configured to monitor and observe periodic change of optical power as the laser light is directed to pixels in successive columns by the column-selection switches. The photocurrent and its variation measured by PDs 814b can therefore be used to monitor the health of the splitters 810 and optical amplifiers 812. If the measured laser power at PD 814b starts to drop, it can be an indication that these components are degrading. If the photocurrents drop below a failure threshold, it can be an indication of catastrophic failures of one or more of these components in the optical path. In some embodiments (described below), the system can be configured to switch or turn on a spare optical amplifier in the event of a failure or degradation.

FIG. 9 shows a schematic of the LiDAR with additional protection switches 932 for the optical amplifiers 912. Without the protection switches 932, the embodiment of FIG. 9 corresponds to the embodiment of FIG. 2, and can include a N×M optical switch 908 coupled to the output of a laser array 906, M sets of 1×K splitters 910, SOAs 912 on the output of each splitter, M*L sub arrays 904 of optical antennas, and receivers 913 for each sub-array. Here the number of the optical amplifiers (K) is larger than the number of sub-arrays (L). Each K×L switch 932 selects the L active optical amplifiers to feed the sub-arrays. The health of the optical amplifiers 912 can be monitored by the PDs 914b at the end of the sub-array waveguides. In case a failure of an optical amplifier is detected, the K×L switch can select a spare optical amplifier for the impacted row.

The operation of the embodiment in FIG. 9 is described below:
(1) After the lasers of the N-element laser array 906 are turned on, monitor the output power of each selected laser with the monitoring PDs 914a at the through ports of the N×M switches 908. The system can select M lasers to feed to the arrays 904 of the LiDAR chip.
(2) Before turning on the row or column-selection switches in the sub-arrays, measure the photocurrent of the monitoring PDs 914b at the end of the sub-array waveguides. If a failure is detected (e.g., a low photocurrent), use the K×L switch 932 to select a spare optical amplifier to feed the sub-array. In some embodiments, the switch 932 can selectively disable the failed channel.
(3) Once all working lasers and optical amplifiers are verified, the system can proceed to scan the LiDAR by turning on the desired row and column-selection switches.
(4) In this embodiment, each active laser supplies optical power to L sub-arrays. By operating M lasers simultaneously, optical power can be supplied to M·L sub-arrays simultaneously. The column-selection switches of different sub-arrays can be electrically connected to reduce the number of electrical I/Os.
(5) The system can continue to check the conditions of the lasers and optical amplifiers by constantly monitoring the photocurrents in the monitoring PDs 914a and 914b. Slow decrease of photocurrents may be due to slow degradation of the active elements. Sudden reduction of photocurrents (e.g., a drop below a failure threshold) could mean catastrophic failure of the active elements.
(6) Once a failure or a potential failure is detected, the protection switch can select a spare laser or spare optical amplifier.
(7) Resume the operation of the LiDAR.

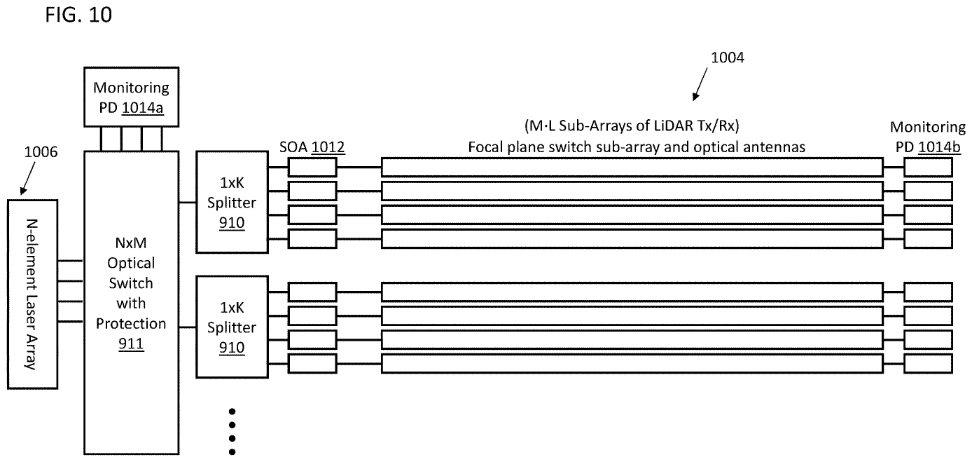

FIG. 10 shows the schematic of the LiDAR transmitter with protection switches integrated the N×M switch 911. This embodiment can be used when a separate receiver chip is used. For example, a single photon avalanche diode (SPAD) array can be used as the receiver for pulsed time-of-flight LiDAR. The focal plane switch array can be used as the transmitter only.

The systems and methods described herein can be used, for example, to perform range (distance) measurement in multiple directions. Additionally, the systems and methods described herein can be used to perform measurement of 3D point clouds. In some embodiments, the frame rate or speed of 3D point cloud measurement can be increased by turning on multiple pixels at the same time. In some examples, these multiple pixels can be powered by the same laser through an optical splitter. In other embodiments, the multiple pixels can be powered by separate lasers.

The present disclosure provides a number of novel and inventive features over present LiDAR designs. The use of a focal plane switch array LiDAR with a split-and-amplify architecture of the present invention provides improved performance. Further, some embodiments implement protection switches in conjunction with spare lasers and optical amplifiers, which also further enables the ability to use spare lasers and optical amplifiers and can increase the fabrication yield of the LiDAR chip. The LiDAR chip is still fully functional even when some lasers or optical amplifiers are defective, as long as the number of defective elements is smaller than the number of spares.

The protection switches and the spare active elements (lasers or optical amplifiers) also increase the reliability of the LiDARs. The integrated monitoring photodiodes can detect failures of the active elements. The defective element can be replaced by a spare element using the protection switches. Since the protection switch operates in microsecond time, the disruption of LiDAR operation is minimized.

This system also enables condition-based maintenance. When slow degradation of the active element is detected, the degrading element can be replaced by a spare before failure occurs. Condition-based maintenance can be performed when the LiDAR is not in use. For example, in automotive LiDARs, switching to one or more spare elements can be scheduled when the cars are parked.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1. An imaging LiDAR system, comprising:
a laser array comprising a plurality of light emitters;
a LiDAR array including a plurality of optical antennas having transmit and receive functions, wherein a number of active channels in the LiDAR array is less than a number of light emitters in the laser array;
a programmable optical network configured to provide a light path from active lasers of the laser array to a selected optical antenna of the LiDAR array; and
a first plurality of monitoring devices configured to monitor a health of the active lasers of the laser array.

2. The system of claim 1 wherein the imaging LiDAR system further comprises an optical switch coupled to the laser array.

3. The system of claim 1 wherein the plurality of optical antennas and the programmable optical network are integrated on a photonic integrated circuit

4. The system of claim 2, wherein the optical switch is configured to select the active lasers from the array of lasers to feed the LiDAR array.

5. The system of claim 4, wherein the first plurality of monitoring devices are coupled to the optical switch.

6. The system of claim 5, wherein the first plurality of monitoring devices comprise at least one monitoring photodiode.

7. The system of claim 6, wherein the at least one monitoring photodiode is positioned at each through port of the optical switch.

8. The system of claim 5, wherein the first plurality of monitoring devices are configured to monitor a photocurrent level of each active laser.

9. The system of claim 1, further comprising a second plurality of monitoring devices configured to monitor periodic change of optical power as light energy is directed to the LiDAR array.

10. The system of claim 9, wherein the second plurality of monitoring devices comprise a plurality of monitoring photodiodes in the LiDAR array.

11. The system of claim 10, wherein the plurality of monitoring photodiodes are integrated into row waveguides of the programmable optical network.

12. The system of claim 5, further comprising a plurality of splitters optically coupled to each active laser.

13. The system of claim 12, further comprising an optical amplifier coupled to each output of the plurality of splitters, the optical amplifiers being configured to compensate for splitting loss through the plurality of splitters.

14. The system of claim 13, further comprising a second plurality of monitoring devices configured to monitor periodic change of optical power as light energy is directed to the LiDAR array through the plurality of splitters and optical amplifiers.

15. The system of claim 14, wherein the second plurality of monitoring devices comprises a plurality of monitoring photodiodes in the programmable optical network.

16. The system of claim 15, wherein a photocurrent measured by the second plurality of monitoring photodiodes can be used to monitor a health of the optical amplifiers.

17. The system of claim 15, wherein the second plurality of monitoring devices are integrated at the end of row waveguides in the LiDAR array.

18. The system of claim 1 wherein the programmable optical network is controlled by one or more micro-electro-mechanical system (MEMS) actuators, or Mach-Zehnder interferometers with electro-optic or thermo-optic phase modulators, or mirroring resonators with electro-optic or thermo-optic phase modulators.

19. The system of claim 1, wherein the imaging LiDAR system further comprises a plurality of splitters optically coupled to the array of lasers and at least one optical amplifier coupled to each of the plurality of splitters, the optical amplifiers configured to compensate for splitting loss through the plurality of splitters.

20. The system of claim 13, further comprising a coupler configured to tap off a small portion of power from the laser array as local oscillator light to a coherent receiver.

21. The system of claim 20, wherein reflected light from the LiDAR array is sent through a directional coupler to be mixed with the local oscillator light.

22. The system of claim 13, further comprising a direct detection receiver optically coupled to each optical amplifier.

23. The system of claim 1, wherein the plurality of optical antennas comprise separate transmit and receive optical antennas, wherein the programmable optical network comprises a transmit waveguide optically connected to the transmit optical antennas and a receive waveguide optically connected to the receive optical antennas.

24. The system of claim 1, further comprising a plurality of optical isolators positioned between the laser array and the LiDAR array, the plurality of optical isolators being configured to suppress residue reflections.

25. The system of claim 2, further comprising a plurality of protection switches positioned between the optical switch and the LiDAR array, the plurality of protection switches being configured to select a spare optical amplifier in the event of a degraded or non-functional optical amplifier.

26-33. (canceled)
